(19) United States
(12) Patent Application Publication
(10) Pub. No.: US 2006/0214628 A1
(43) Pub. Date: Sep. 28, 2006

(54) Induction charger assembly and electronic device employing the same

(75) Inventor: Ching-Chou Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/384,684

(22) Filed: Mar. 20, 2006

(30) Foreign Application Priority Data
Mar. 26, 2005 (CN) 200510033844.7

(51) Int. Cl. H02J 7/00

(52) U.S. Cl. 320/108

(57) ABSTRACT

An induction charger assembly (3) is provided for an electronic device (4). The induction charger assembly includes an induction coil (311), a charger connector (35), and a magnetic element (313). The induction coil is configured to be hollow column in shape, and the induction coil has a first end and a second end. The charger connector electrically connects with the first and second ends of the induction coil. The charger connector is configured for electrically connecting with the electronic device to be charged. The magnetic element is received in the induction coil. The permanent magnet is movable in the induction coil for generating an induction current through the induction coil.

### BACKGROUND OF THE INVENTION

1. Field of the Invention

The present invention generally relates to induction charger assemblies and, more particularly, to an induction charger assembly for use in a portable electronic device.

2. Discussion of Related Art

With the development of wireless communication and information processing technologies, portable electronic devices such as mobile telephones and electronic notebooks are now in widespread use. These portable electronic devices enable consumers to enjoy high technology services anytime and anywhere.

Rechargeable batteries are widely used in portable electronic devices, conventionally being attachably received in a housing of the electronic device. The battery has to be recharged once the battery is exhausted. When the user is at home, it is easy to recharge the battery from a mains power source. However, when the user is away from a mains power source, it is hard to recharge the battery.

Therefore, a new induction charger assembly is desired in order to overcome the above-described shortcomings.

### SUMMARY

In one aspect, an induction charger assembly is provided for an electronic device. The induction charger assembly includes an induction coil, a charger connector, and a magnetic element. The induction coil is configured to be hollow column in shape, and the induction coil has a first end and a second end. The charger connector electrically connects with the first and second ends of the induction coil. The charger connector is configured for electrically connecting with the electronic device to be charged. The magnetic element is received in the induction coil. The permanent magnet is movable in the induction coil for generating an induction current through the induction coil.

In another aspect, an electronic device employing an induction charger is provided. The electronic device includes a device body, a battery, and a charger assembly. The battery and the charger assembly are mounted to the device body. The battery has a battery connector. The charger assembly includes an induction coil and a magnet element. The induction coil has a first end and a second end. The first and second ends electrically connect with the batter connector. The magnet element is movably received in the induction coil.

Other advantages and novel features of the embodiments will become more apparent from the following detailed description thereof when taken in conjunction with the accompanying drawings.

### BRIEF DESCRIPTION OF THE DRAWINGS

Many aspects of the present induction charger assembly can be better understood with reference to the following drawings. The components in the drawings are not necessarily to scale, the emphasis instead being placed upon clearly illustrating the principles of the charger assembly and its potential applications. Moreover, in the drawings, like reference numerals designate corresponding parts throughout the several views.

FIG. 1 is an assembled, isometric view of an induction charger assembly for a portable electronic device in accordance with a preferred embodiment of the present invention;

FIG. 2 is a partly cross-sectional, exploded view of the induction charger assembly shown in FIG. 1; and

FIG. 3 is an isometric view of a portable electronic device with an induction charger assembly in accordance with another preferred embodiment of the present invention.

### DETAILED DESCRIPTION OF THE EMBODIMENTS

The present induction charger assembly is suitable for portable electronic devices such as mobile phones, PDAs, and so on.

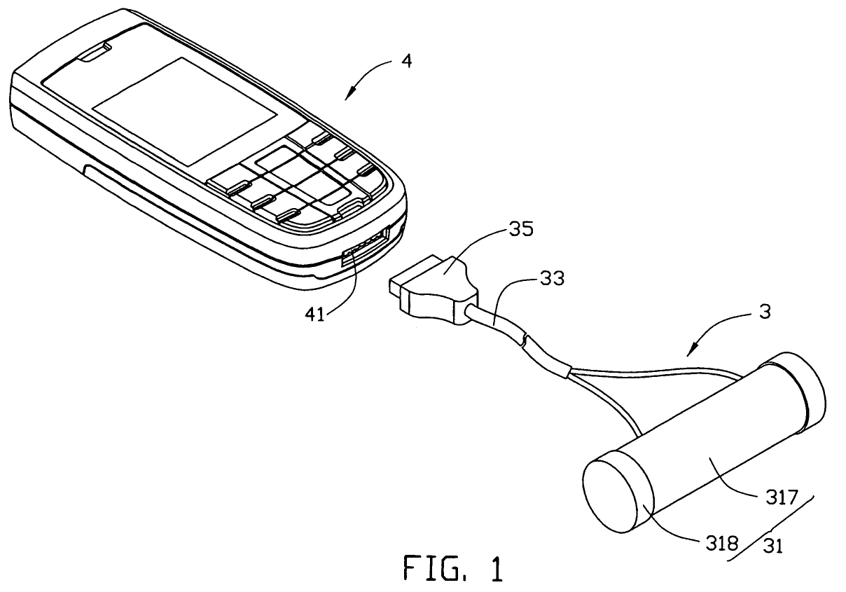

Referring now to the drawings in detail, FIG. 1 shows an induction charger assembly 3 for use with a mobile phone 4. The mobile phone 4 is taken here as an exemplary application, for the purposes of describing details of the induction charger assembly 3 of a preferred embodiment of the present assembly. The mobile phone 4 has a charging socket 41 formed at one end thereof.

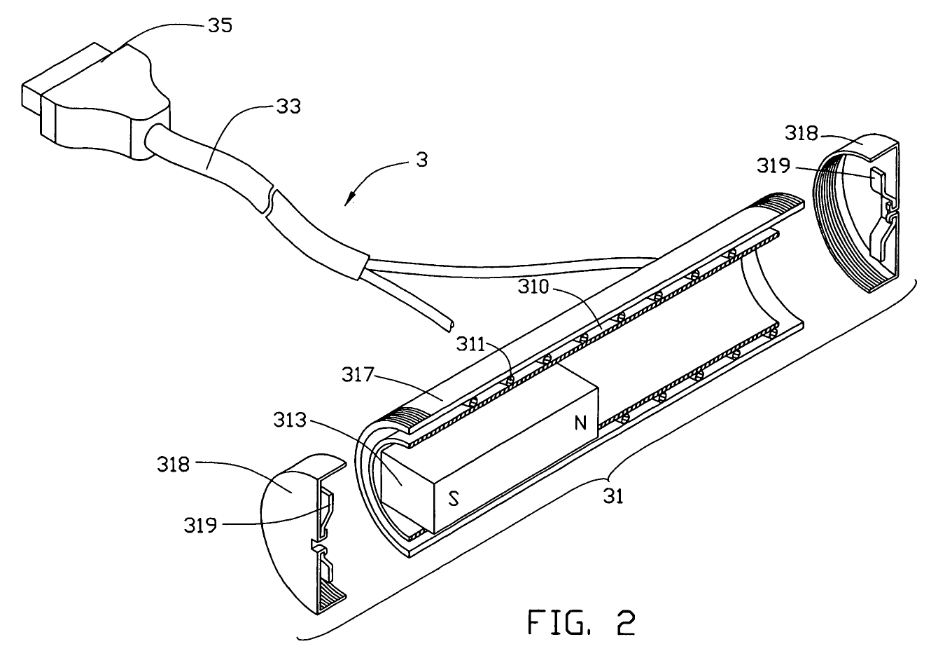

Also referring to FIG. 2, the induction charger assembly 3 includes an induction generator 31, a transmission line 33, and a plug connector 35. The transmission line 33 electrically connects the induction generator 31 and the plug connector 35. The induction charger assembly 3 is electrically connected with the mobile phone 4 by the plug connector 35 connecting with the charging socket 41, for recharging a battery (not shown) received in a body (not labeled) of the mobile phone 4. A rectifying circuit (not shown) is received in the plug connector 35 for rectifying the electrical current flowed to the mobile phone 4.

The induction generator 31 includes a first barrel 310, an induction coil 311, a permanent magnet 313, a second barrel 317, a pair of covers 318, and a pair of elastic members 319 such as elastic slices. Alternatively, the elastic member 319 may be a spring. The first barrel 310 and the second barrel 317 are both in the form of a hollow cylinder. The permanent magnet 313 is received in the first barrel 310 for producing a magnetic field, and is movable relative to the first barrel 310. The induction coil 311 surrounds an outer surface of the first barrel 310, and has a first end and a second end. The transmission line 33 is electrically connected with the first and second ends of the induction coil 311, for transmitting the electrical current produced by the induction coil 311 to the plug connector 35. An outer diameter of the first barrel 310 is smaller than an inner diameter of the second barrel 317. The first barrel 310 with the induction coil 311 and the permanent magnet 313 is received in the second barrel 317. The two covers 318 respectively enclose two ends of the second barrel 317 for accommodating the first barrel 310, the induction coil 311, and the permanent magnet 313 therein. A central portion of each elastic slice 319 is bent towards and in contact with an inner surface of each cover 318.

The induction generator 31 operates on the principle of electromagnetic induction. When the battery in the mobile phone 4 is in need of recharging, the plug connector 35 of the induction charger assembly 3 is connected with the charging socket 41 of the mobile phone 4. The second barrel 317 is swayed to cause the permanent magnet 313 to move in the first barrel 310. When the permanent magnet 313 reaches one elastic slice 319, the permanent magnet 313 moves to a contrary direction due to the action of the elastic slice 319. When the permanent magnet 313 moves to-and-fro in the first barrel 310, a magnetic flux of the induction coil 311 is changed thereby producing an electric current in the induction coil 311. The electric current produced by the induction generator 31 is transmitted to the plug connector 35 by the transmission line 33 and is rectified in the rectifying circuit of the plug connector 35. The rectified current then flows to the battery of the mobile phone 4.

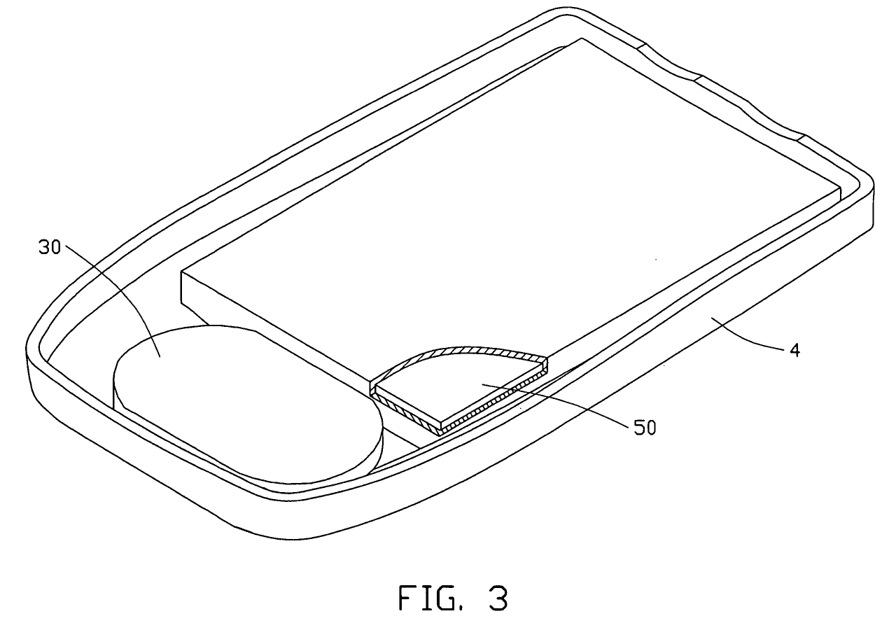

The charger assembly may be directly mounted to the mobile phone 4. Referring to FIG. 3, one charger assembly 30 is mounted in the mobile phone 4, being electrically connected and located adjacent to a battery 50 thereof. The charger assembly 30 has a substantially same configuration as that of the charger assembly 3 as shown in FIG. 1. Understandably, in this case, the plug connector 35 and the charging socket 41 may be omitted, and the induction coil 311 is connected to a battery connector of the mobile phone 4, either directly or via another connector.

As described above, the preferred embodiment provides an induction charger assembly 3 for portable electronic devices such as mobile phones. When a user is away on a journey, the induction charger assembly 3 may be received in a pocket of the user, or worn on the foot or leg of the user. When the user moves, the permanent magnet 313 moves with them, thereby generating electricity. It is thus made easy for a user to recharge the mobile phone 4 when away from a mains power supply.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An induction generator configured for generating electrical current to recharge a battery, the induction generator comprising:
a first barrel;
an induction coil surrounding the first barrel; and
a magnetic element movably received in the first barrel.

2. The induction generator as claimed in claim 1, further comprising a plug connector, wherein the plug connector is configured for electrically connecting with the induction generator and an electronic device to be charged.

3. The induction generator as claimed in claim 2, further comprising a transmission line, wherein the transmission line electrically connects the plug connector with the induction coil.

4. The induction generator as claimed in claim 1, further comprising a second barrel, wherein the first barrel, the induction coil, and the permanent magnet are received in the second barrel.

5. The induction generator as claimed in claim 1, further comprising a pair of covers, wherein the first barrel has a pair of opposite open ends, and the covers close the two open ends of the first barrel.

6. The induction generator as claimed in claim 5, wherein an elastic member is formed on each cover at an inner side thereof.

7. The induction generator as claimed in claim 1, wherein the magnetic element is a permanent magnet.

8. An induction charger assembly comprising:
an induction coil configured to be hollow column in shape, the induction coil having a first end and a second end;
a charger connector electrically connected with the first and second ends, the charger connector being configured for electrically connecting with an electronic device to be charged; and
a magnetic element received in the induction coil, the permanent magnet being movable in the induction coil for generating an induction current through the induction coil.

9. The charger assembly as claimed in claim 8, further comprising a first barrel, wherein the induction coil surrounds the first barrel, and the permanent magnet is received in the first barrel.

10. The charger assembly as claimed in claim 9, further comprising a second barrel, wherein the first barrel, the induction coil, and the permanent magnet are received in the second barrel.

11. The charger assembly as claimed in claim 8, wherein the magnetic element is a permanent magnet.

12. An electronic device comprising:
a device body;
a battery mounted to the device body, the battery having a battery connector; and
a charger assembly mounted to the device body, the charger assembly comprising:
an induction coil having a first end and a second end, the first and second ends electrically connected with the batter connector; and
a magnet element movably received in the induction coil.

13. The electronic device as claimed in claim 12, further comprising a first barrel, wherein the induction coil surrounds the first barrel, and the permanent magnet are received in the first barrel.

14. The electronic device as claimed in claim 13, further comprising a second barrel, wherein the first barrel, the induction coil, and the permanent magnet are received in the second barrel.

15. The electronic device as claimed in claim 12, wherein the magnetic element is a permanent magnet.
